(19) United States
(12) Patent Application Publication
(10) Pub. No.: US 2006/0056469 A1
(43) Pub. Date: Mar. 16, 2006

(54) Method and device for generating an optical laser pulse

(76) Inventors: Dieter Huhse, Berlin (DE); Olaf Reimann, Berlin (DE); Dieter Bimberg, Berlin (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/529,199

(22) PCT Filed: Sep. 22, 2003
(86) PCT No.: PCT/DE03/03212

§ 371 Date: Jun. 22, 2005

(30) Foreign Application Priority Data
Sep. 25, 2002 (DE) 102 45 717.4

(51) Int. Cl. H01S 3/13

(52) U.S. Cl. 372/30

(57) ABSTRACT

The invention relates to a method for generating optical laser pulses (Po). In order to generate a particularly low-jitter optical signal, an optical injection pulse (I) of a secondary laser (50) is fed into a main laser (30). Feeding is done in such a way that the optical injection pulse arrives in the main laser (30) when the charge carrier density inside the main laser (30) has just reached or just exceeds the threshold charge carrier density.

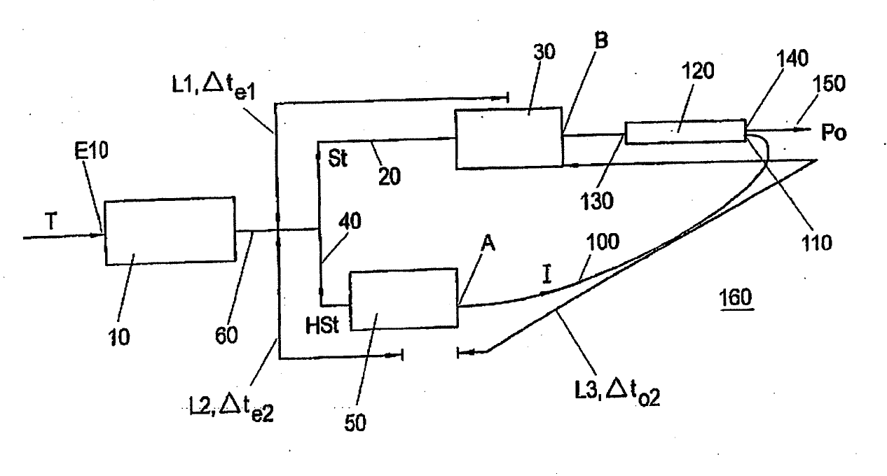

The invention relates to a method for generating an optical laser pulse.

A method for generating laser pulses is known, in the case of which the auxiliary laser is operated in continuous operation—that is to say in nonpulsed fashion—(“Laser Diode Modulation and Noise”, K. Petermann, 1988, Kluwe Academic Publishers, page 46).

A method for “self-injection” is further described in the published German patent application 199 41 122 A1. In the case of this method, the light from a laser is coupled into an optical fiber via a lens. A fiber grating with a reflectivity of between 2% and 50% is written in the optical fiber, the spectral half value width of said grating being less than the spacing of the Fabry-Perot modes of the laser. The light fed back into the laser from the optical fiber reacts upon the light emission in the laser, as a result of which short and low-jitter pulses can be generated.

The invention is based on the object of specifying a method in which low-jitter optical laser pulses are generated with a freely selectable repetition rate. In this case, the term “jitter” is understood to mean a temporal fluctuation or noise of the pulse position of the optical laser pulses, be it relative to other laser pulses respectively generated beforehand or be it relative to the electrical control signal that generates the respective optical laser pulse.

In order to achieve this object, the invention provides a method having the features of claim 1. Advantageous refinements of the method according to the invention are described in subclaims 2 to 10.

Accordingly, it is provided that the optical injection pulse of the auxiliary laser is generated in such a way that it arrives in the main laser at a point in time at which, on account of the control signal, the charge carrier density in the main laser has just reached or just exceeds the threshold charge carrier density.

An essential advantage of the method according to the invention is that it can be used to generate very low-jitter laser pulses—to be precise independently of the repetition rate. This will now be briefly explained: during the generation of an optical injection pulse, for example by means of a semiconductor laser, it is possible—as viewed in the temporal profile—firstly to observe a spontaneous emission, which is attributable to an uncoordinated recombination of electron-hole pairs. It is only temporally afterward that the induced recombination occurs on account of the population inversion having been achieved. If this injection pulse, which is still relatively beset by jitter—in relation to the electrical auxiliary control signal—due to the spontaneous emission, is then radiated into the main laser at the “correct” point in time, the electron-hole pairs which are provided, and as it were are “waiting” for photons, in the main laser, will immediately recombine in an avalanche-like manner and generate an optical “output laser pulse” (laser pulse) in which the proportion of the spontaneous emission is relatively small. The resulting laser pulse of the main laser is thus also relatively free of “jitter”. In essence, the inventive idea thus consists in providing an injection pulse precisely at the point in time at which the main laser has just achieved the population inversion on account of its dedicated driving.

A further essential advantage of the method according to the invention is that it is possible to generate optical laser pulses with an arbitrary repetition rate without losing the property of the method according to the invention, namely that low-jitter pulses are generated; thus, in contrast to the “self-injection method” in accordance with the abovementioned published German patent application 199 41 122 A1, a cavity whose length fixedly predetermines the repetition rate of the laser pulses is not present.

A third essential advantage of the method according to the invention can be seen in the fact that a relatively simple and thus inexpensive auxiliary laser can be used since the auxiliary laser is required exclusively for “triggering” the laser pulses; consequently, continuous operation (“cw operation”) of the auxiliary laser with high continuous power, as is described in the abovementioned book by K. Petermann, is not necessary. Incidentally, “cw operation” generates a “background signal” that is always present and that is disturbing in many applications; such a “background signal” is greatly reduced in the case of the method according to the invention.

In order to trigger the avalanche-like induced emission of the main laser, it is regarded as advantageous if the wavelength of the optical injection pulse and the wavelength of the light of the main laser are essentially identical. The wavelength of the optical injection pulse advantageously lies within the gain bandwidth of the main laser.

In order to ensure in a simple manner and thus advantageously that the optical injection pulse arrives in the main laser “at the correct point in time”, it is regarded as advantageous if the optical injection pulse is generated by application of an electrical auxiliary control signal, the auxiliary control signal being applied to the auxiliary laser temporally before the control signal is applied to the main laser, and the time difference between the application of the control signal to the main laser and the application of the auxiliary control signal to the auxiliary laser corresponding at least to the time period. required by the optical injection pulse from the auxiliary laser to the main laser. This advantageous refinement of the method according to the invention takes account of the fact that the optical injection pulse has to cover an optical path length before it reaches the main laser coming from the auxiliary laser.

In this case, the time-offset application of the electrical control signal and of the electrical auxiliary signal can be achieved in an advantageous manner by suitably selecting the electrical propagation times of the control signal and of the auxiliary control signal to the main and auxiliary lasers.

In this case, the electrical control signal and the electrical auxiliary control signal may be generated by the same signal generator; in this case, the signal generator is then to be connected to the main laser via a first drive line and to the auxiliary laser via a second drive line. In this case, the first drive line and the second drive line need not be totally separate individual lines over their entire line length; it is to be regarded as advantageous, rather, with regard to a saving of material if the first and second drive lines jointly use the same wire or the same line at least in sections.

The control signal and the auxiliary control signal may also be generated by two signal generators instead of by a single signal generator. In order to ensure in this case that the signals are “in time”, the signal generators should preferably be synchronized or triggered, for example by a common trigger signal.

As already explained above, it is advantageous if the propagation times of the electrical signals (i.e. of the control signal and of the auxiliary control signal) are taken into account; this can be carried out in a simple manner and thus advantageously by suitably selecting the line lengths of the electrical drive lines; by way of example, the length of the first drive line may be selected in such a way that the propagation time of the control signal to the main laser is of the same magnitude as the propagation time sum resulting from addition of the propagation time required by the auxiliary control signal to the auxiliary laser via the second drive line and the propagation time required by the optical injection pulse from the auxiliary laser to the main laser.

The feeding of the injection pulse into the main laser can advantageously be achieved via an optical splitter, in particular a fiber splitter, via which the laser pulse generated by the main laser is also coupled out.

Since semiconductor lasers are particularly cost-effective, it is regarded as advantageous if the optical injection pulse and/or the optical laser pulse are generated by a semiconductor laser. By way of example, DFB (DFB: Distributed Feedback) lasers or DBR (DBR: Distributed Bragg Reflection) lasers may be used as the main and auxiliary lasers. The advantage of DFB lasers and DBR lasers is that they are essentially monomode lasers, that is to say emit their laser light in a predetermined mode.

In accordance with a particularly preferred development of the method according to the invention, a Fabry-Perot laser is used as the main laser and a DFB laser or a DBR laser is used as the auxiliary laser. A Fabry-Perot laser is relatively cost-effective; however, it has the disadvantage that it is a multimode laser or oscillates in “multimode” fashion. However, as has been ascertained by the inventors, this disadvantage is not manifested in the present case if a DFB or DBR laser is used as the auxiliary laser. The monomode injection pulse of the essentially monomode auxiliary laser excites exclusively the associated mode of the main laser, so that the Fabry-Perot laser will always oscillate in the predetermined mode despite its construction-dictated or component-typical multimode nature. As a result, in accordance with the preferred development, the method according to the invention is thus carried out particularly cost-effective in monomode operation because a cost-effective Fabry-Perot laser is used as the main laser. In other words, then, compared with a solution in which two relatively expensive lasers (e.g. DFB or DBR lasers) operating in monomode fashion are used as the main and auxiliary lasers, one of the two expensive lasers is replaced by a particularly cost-effective Fabry-Perot laser.

What is more, the method according to the invention can be used to generate not only an individual laser pulse but also—successively—a multiplicity of low-jitter laser pulses, that is to say a laser pulse train; thus, it is therefore regarded as advantageous if the method according to the invention is used for example for message transmission.

The invention is additionally based on the object of specifying a device which makes it possible to generate a particularly low-jitter optical laser pulse with a freely selectable, that is to say arbitrary, repetition rate.

This object is achieved according to the invention by means of a device having the features in accordance with claim 11. Advantageous refinements of the device according to the invention are described in subclaims.

With regard to the advantages of the device according to the invention and its advantageous refinements, reference is made to the above embodiments concerning the method according to the invention.

In order to elucidate the invention, a FIGURE shows an exemplary embodiment of a device according to the invention, which can also be used to carry out the method according to the invention.

The FIGURE shows a signal generator 10, which is connected to a main laser 30—preferably a multimode Fabry-Perot semiconductor laser—on the output side via a first drive line 20. The signal generator 10 is connected to an auxiliary laser 50 on the output side via a second drive line 40, said auxiliary laser preferably being a DFB semiconductor laser oscillating in monomode fashion or a DBR semiconductor laser oscillating in monomode fashion. The first drive line 20 and the second drive line 40 have a common line section 60; the two drive lines 20 and 40 are formed by a single conductor or a single line on said common line section 60. The two drive lines 20 and 40 thus share said common line section 60.

At an optical output A of the auxiliary laser 50, one end of an optical transmission line 100, e.g. of an optical fiber or a polymer line, is connected to the auxiliary laser 50. Said transmission line 100 is connected by its other end to a first terminal 110 of a fiber-optic splitter. A second terminal 130 of the fiber-optic splitter 120 is connected to an optical output B of the main laser 30. A third terminal 140 of the fiber-optic splitter 120 forms the optical output 150 of a device 160 for generating low-jitter optical laser pulses Po, which device is formed by the signal generator 10 the two lasers 30 and 50 and the fiber-optic splitter 120.

The device 160 is operated as follows:

At an input E10 of the signal generator 10, a trigger or synchronization signal T is applied to the signal generator 10. When the trigger signal T is input, the signal generator 10 generates a Gaussian pulse p having a predetermined length; this pulse p forms an electrical control signal St for the main laser 30 and an electrical auxiliary control signal HSt for the auxiliary laser 50.

On account of the line length L1 of the first drive line 20, the control signal St requires a propagation time Δtₑ₁ in order to pass from the signal generator 10 to the main laser 30.

The auxiliary control signal HSt requires a propagation time of Δtₑ₂ for its path via the second drive line 40 having the length L2.

If the auxiliary control signal HSt then arrives in the auxiliary laser 50, electron-hole pairs are generated in the auxiliary laser 50. As soon as the population inversion has been achieved in the auxiliary laser 50, the laser operation of the auxiliary laser 50 begins and an optical injection pulse I is emitted at the output A.

The time period that elapses between the arrival of the auxiliary control signal HSt and the population inversion being achieved or the emission of the optical injection pulse I will be designed as Δtᵢ₂ hereinafter.

The optical injection pulse I thus generated in the auxiliary laser 50 then passes via the optical transmission line 100 to the fiber-optic splitter 120 and from there to the main laser 30. The optical injection pulse I requires the time Δtₒ₂ for this path from the auxiliary laser 50 to the main laser 30.

The device 160 according to the FIGURE is dimensioned, then, in such a way that population inversion is just achieved in the main laser 30 at the point in time when the injection pulse I arrives; that is to say that the main laser is on the brink of itself undergoing transition to laser operation. The way in which this “dimensioning” of the device 160 is achieved will now be explained in detail:

As already described, there elapses from the point in time at which the auxiliary control signal HSt was generated until the point in time at which the optical injection pulse I reaches the main laser 30 a time period Δtₜₒₜ₂ composed in accordance with:
Δtₜₒₜ₂=Δtₑ₂+Δtᵢ₂+Δtₒ₂.
The control signal St requires a time period Δtₑ₁ on the first drive line 20 for its path from the signal generator 10 to the main laser 30. After the “arrival” of the control signal St, electron-hole pairs are generated in the main laser 30 because a corresponding current flows through the main laser 30 on account of the control signal St. The time period until a population inversion is present in the main laser 30 will now be designated by Δtᵢ₁.

If the intention then, is to have the effect that population inversion is just achieved in the main laser 30 when the optical injection pulse I arrives in the main laser 30, the following condition has to be met:
Δtₑ₁+Δtᵢ₁=Δtₜₒₜ₂=Δtₑ₂+Δtᵢ₂+Δtₒ₂.

Since Δtᵢ₁ has approximately the same magnitude as Δtᵢ₂ and it holds true, moreover, that:
Δtᵢ₁<<Δtₑ₁ and Δtᵢ₂<<Δtₑ₂+Δtₒ₂,
this yields the simplified condition:
Δtₑ₁=Δtₑ₂+Δtₒ₂.

This simplified condition therefore means that the propagation time of the electrical control signal St is to be adapted to the propagation time sum resulting from addition of Δtₑ₂ and Δtₒ₂.

The propagation times can then be adapted in different ways: thus, by way of example, the adaptation may be effected by means of the selection of the electrical properties of the two electrical drive lines, for example by suitably selecting the dielectrics in the lines and thus the dielectric constants, which would result in different phase velocities of the electrical signals on the drive lines.

However, an adaptation by means of the selection of the lengths of the two electrical drive lines is also conceivable. This will now be explained in more detail below using an example in which it is assumed that the optical injection pulse I is transmitted via an optical fiber having a length L3 (refractive index n=1.5). For the sake of simplicity, the electrical drive lines will be coaxial conductors without a dielectric:

$$\begin{matrix}Δ {t}_{el} = Δ {t}_{e2} + Δ {t}_{o2} \\ L1 / c = L2 / c + L3 / ( c / n ) \\ ⇒ L1 = L2 + n \cdot L3 \\ = L2 + 1.5 \cdot L3\end{matrix}$$

As a result, the propagation time adaptation can thus be achieved by suitably providing the length L1 of the first drive line 20. Instead of this, it is also possible, of course, to correspondingly adapt the length L2 of the second drive line 40 or the length L3 of the optical transmission path 100.

A fine adaptation of the propagation times can advantageously be achieved by means of a phase shifter or a delay line. This may involve an electrical phase shifter or an electrical delay line arranged in the first or in the second drive line 20 or 40, or an optical phase shifter or an optical delay line in the optical transmission path 100.

### REFERENCE SYMBOLS

10 Signal generator

20 First drive line

30 Main laser

40 Second drive line

50 Auxiliary laser

60 Common line section

100 Optical transmission line

110 First terminal of a fiber-optic splitter

120 Fiber-optical splitter

130 Second terminal of the optical splitter

140 Third terminal of the fiber-optic splitter

150 Output of the device

160 Device

A Optical output of the auxiliary laser

B Optical output of the main laser

T Trigger signal

I Optical injection pulse

Po Optical laser pulse

St Control signal

HSt Auxiliary control signal

L1, L2, L3 Lengths

E10 Input of the signal generator

Δtₑ₁ Propagation time via the first drive line

Δtₑ₂ Propagation time via the second drive line

Δtᵢ₁ Time to achieve the population inversion in the main laser

Δtᵢ₂ Time to achieve the population inversion in the auxiliary laser

Δtₒ₂ Time for transmission of the optical injection signal I to the main laser

1. A method for generating an optical laser pulse (Po), in which
a main laser (30) is driven with an electrical control signal (St), and
the optical laser pulse (Po) is generated by means of the main laser (30),
an optical injection pulse (I) of an auxiliary laser (50) being fed into the main laser (30), and
the optical injection pulse (I) being generated in such a way that it arrives in the main laser (30) at a point in time at which, on account of the control signal (St), the charge carrier density in the main laser (30) has just reached or just exceeds the threshold charge carrier density.

2. The method as claimed in claim 1,
characterized in that
the optical injection pulse (I) is generated by application of an electrical auxiliary control signal (HSt),
the auxiliary control signal (HSt) being applied to the auxiliary laser (50) temporally before the control signal (St) is applied to the main laser (30), and
the time difference between the application of the control signal (St) to the main laser (30) and the application of the auxiliary control signal (HSt) to the auxiliary laser (50) corresponding to the time period required by the optical injection pulse (I) from the auxiliary laser (50) to the main laser (30).

3. The method as claimed in claim 2,
characterized in that
the time-offset application of the electrical control and auxiliary control signals (St, HSt) is effected by suitably selecting the electrical propagation times of the control signal (St) and of the auxiliary control signal (HSt) to the main and auxiliary lasers.

4. The method as claimed in claim 3,
characterized in that
the electrical control signal (St) and the auxiliary control signal (HSt) are generated by the same signal generator (10),
the signal generator (10) being connected to the main laser (30) via a first drive line (20) and to the auxiliary laser (50) via a second drive line (40).

5. The method as claimed in claim 3,
characterized in that
the control signal and the auxiliary control signal are generated by two synchronized signal generators,
one signal generator being connected to the main laser via a first drive line and the further signal generator being connected to the auxiliary laser via a second drive line.

6. The method as claimed in claim 4,
characterized in that
the length (L1) of the first drive line (20) is selected in such a way that the propagation time of the control signal (St) to the main laser (30) is of the same magnitude as the propagation time sum resulting from addition of the propagation time required by the auxiliary control signal (HSt) to the auxiliary laser (50) via the second drive line (40) and the propagation time required by the optical injection pulse (I) from the auxiliary laser (50) to the main laser (30).

7. The method as claimed in claim 1, characterized in that
the optical injection pulse (I) of the auxiliary laser (50) is fed into the main laser (30) via an optical splitter (120), and
the optical laser pulse (Po) of the main laser (30) is coupled out via said optical splitter (120).

8. The method as claimed in claim 1, characterized in that
the optical injection pulse and/or the optical laser pulse are generated by a semiconductor laser.

9. The method as claimed in claim 1, characterized in that
the optical injection pulse is generated by a laser that emits essentially in monomode fashion, preferably a DFB laser or a DBR laser, and the optical laser pulse is generated by a multimode laser, preferably a Fabry-Perot laser, (30).

10. The method as claimed in claim 1, characterized in that
a multiplicity of optical laser pulses are generated in the manner described.

11. A device for generating an optical laser pulse (Po) having
a main laser (30), which is driven with an electrical control signal (St) and generates the optical laser pulse (Po), and
an auxiliary laser (50), which is optically connected to the main laser (30) and feeds an optical injection pulse (I) into the main laser (30),
an electrical auxiliary control signal (HSt) being applied to the auxiliary laser (50) in such a way that its optical injection pulse (I) arrives in the main laser (30) at a point in time at which the charge carrier density of the main laser (30) has just reached or just exceeds the threshold charge carrier density.

12. The device as claimed in claim 11,
characterized in that
the auxiliary control signal (HSt) is present at the auxiliary laser (50) before the control signal (St) is present at the main laser (30),
to be precise in a manner time-offset by a time difference corresponding to the time period required by the optical injection pulse (I) from the auxiliary laser (50) to the main laser (30).

13. The device as claimed in claim 12,
characterized in that
the time-offset application of the electrical control and auxiliary control signals (St, HSt) is effected by suitably selecting the electrical propagation times of the control signal (St) and of the auxiliary control signal (HSt) to the main and auxiliary lasers (30, 50).

14. The device as claimed in claim 13,
characterized in that
the main laser (30) and the auxiliary laser (50) are connected to the same signal generator (10) via a first drive line (20) and via a second drive line (40), respectively, said signal generator generating the electrical control signal (St) for the main laser (30) and the auxiliary control signal (HSt) for the auxiliary laser (50).

15. The device as claimed in claim 14,
characterized in that
the main laser (30) is connected to one signal generator (10) via a first drive line (20) and the auxiliary laser (50) is connected to a further signal generator (10) via a second drive line (40),
the two signal generators (10) being synchronized.

16. The device as claimed in claim 14,
characterized in that
the length of the first drive line (20) is selected in such a way that the propagation time of the control signal (St) to the main laser (30) is of precisely the same magnitude as the propagation time sum resulting from addition of the propagation time required by the auxiliary control signal (HSt) to the auxiliary laser (50) via the second drive line (40) and the propagation time required by the optical injection pulse (I) from the auxiliary laser (50) to the main laser (30).

17. The device as claimed in claim 11,
characterized in that
the main laser (30) is connected to the auxiliary laser (50) via an optical splitter.

18. The device as claimed in claim 11,
characterized in that
the auxiliary laser (50) and/or the main laser (30) are/is a semiconductor laser.

19. The device as claimed in claim 11,
characterized in that
the auxiliary laser (50) is a laser that emits essentially in monomode fashion, preferably a DFB laser or a DBR laser, and the main laser (30) is a laser that emits in multimode fashion, preferably a Fabry-Perot laser.
